(19) United States
(12) Patent Application Publication
(10) Pub. No.: US 2016/0365087 A1
(43) Pub. Date: Dec. 15, 2016

(54) HIGH END SPEECH SYNTHESIS

(71) Applicant: GEULAH HOLDINGS LLC, Los Angeles, CA (US)

(72) Inventor: STEVEN DAVID FREUD, Woodland Hills, CA (US)

(21) Appl. No.: 14/738,556

(22) Filed: Jun. 12, 2015

(51) Int. Cl. G10L 13/10

(52) U.S. Cl. CPC G10L 13/10

(57) ABSTRACT

A guide track based speech synthesis system and method that uses an imitator voice and extracted parameter from the imitator voice to enhance the speech synthesized by conventional approach using the library built from an original voice with performance idiosyncrasies, emotions, and characteristics. The imitator voice reads from an input script to recorded speech in substantially the same way as the original voice. The recorded speech is stored in a guide track. Prior recordings of audio from the original voice are used to build a voice library. Context features and prosodic features are extracted from the guide track and corrected. Spectral features which align with the context features and prosodic features of the guide track are generated from the voice library. The aligned acoustic features are then converted to a speech waveform of an enhanced synthetic voice.

### FIELD OF THE INVENTION

The present invention relates generally to a guide track based speech synthesis system and method that uses an imitator voice and extracted parameter from the imitator voice to enhance the speech synthesized by conventional approach using the library built from an original voice with performance idiosyncrasies, emotions, and characteristics. More so, a guide track based speech imitation system and method utilizes an imitator voice that reads an input script to substantially match the original voice, and then extracts, corrects, and aligns a context feature and an acoustic feature from the imitator voice to integrate with the original voice in a Text To Speech (“TTS”) Engine, such that the original voice is replicated with emotion and added vocabulary that the original voice may never have uttered before.

### BACKGROUND OF THE INVENTION

It is known that speech synthesis involves the artificial production of human speech. A computer system used for this purpose is called a speech synthesizer, and can be implemented in software or hardware. Typically, a speech-to-text system performs speech synthesis by converting normal language into speech (or text into speech). Furthermore, speech systems are available that render symbolic linguistic representations like phonetic transcriptions into speech to facilitate voice interfacing.

Often, it is desirable to mimic a voice for public announcements, movie productions, communication devices, etc. This speech replication may be performed by reading out text from a received message in an original voice. However, this approach results in speech output that is monotonous and lacking spontaneity, and which may be difficult to understand for users in different geographical regions who are accustomed to different accents to that of the predefined voice. It would be more helpful for the user to listen to the script in a natural voice.

Generally, HMM-based parametric speech synthesis is a mainstream approach used to build a speech synthesis system. In this approach, spectral features and F0s are extracted from the speech database by a speech vocoder and are modeled by hidden Markov models (HMMs) at training time. Given an input text for synthesis, its corresponding spectral and F0 features can be predicted using the trained model. These are then sent into a vocoder to reconstruct speech waveforms. However, because of the limitation of acoustic modeling, it is difficult to synthesize speech with rich emotion and expressiveness, which are mostly carried by the prosodic features, e.g. durations and F0s, of the synthetic speech.

It is known that statistical parametric speech synthesizers have recently shown their ability to produce natural-sounding and flexible voices. Unfortunately, because the process relies on a vocoder, the resulting voice has a slightly electronic tinged sound. The vocoder process can produce a sonic artifact that causes the voice to sound artificial and unnatural. It does not, by itself, provide a sufficient level of naturalness and emotional expressiveness needed for a wide range of commercial applications. Furthermore, building a vocabulary of dead celebrities for integrating into statistical parametric speech synthesizers is problematic.

Thus, an unaddressed need exists in the industry to address the aforementioned deficiencies and inadequacies. Even though the above cited voice imitation systems meet some of the needs of the market, a guide track based speech imitation system and method that utilizes an imitator voice that substantially matches the original voice, and then extracts, corrects, and aligns a context feature and an acoustic feature from the imitator voice to integrate with the original voice in a TTS Engine is still desired.

### SUMMARY OF THE INVENTION

The present invention is directed to a guide track based speech synthesis system and method that incorporates speech parameters from an imitator voice into an original voice, such as the voice of a dead celebrity. The imitator voice attempts to substantially match the original voice, such as a professional voice impersonator for optimizing the speech enhancement. The imitator voice reads from an input script to record words in substantially the same way as the original voice. The recorded words are stored in a guide track. Prior recordings of audio from the dead celebrity are used to build a voice library. At least one context feature and at least one acoustic feature are extracted from the guide track, corrected, and aligned for integration into the voice library.

Either manually, or through software the voice data may be manipulated to generate at least one aligned acoustic feature, which a TTS Engine then converts to a speech waveform with the enhanced original voice. The enhanced performance idiosyncrasies and characteristics generated by the TTS engine may include matching the amplitude, cadence, phrasing, rhythm, accent, or dialect of the imitator voice with the original voice. In this manner, the original voice can be recreated using words with a range of emotions that the original voice never expressed.

In one embodiment, the guide track based speech imitation method, hereafter, “method” is efficacious for enhancing the performance idiosyncrasies and characteristics of an original voice through extraction, correction, and alignment of voice parameters, such as at least one context feature and at least one acoustic feature, from a recorded imitator voice. The method incorporates an imitator voice with an original voice, and then utilizes software or manual manipulations to correct, align, and mix the context feature and acoustic feature, such that the original voice speaks with rich character and emotion that was never uttered before.

In one exemplary embodiment, the imitator voice is recorded in a guide track to substantially match the original voice. Separately, the original voice is constructed in a voice library. Using the context feature and acoustic feature from the imitator voice, a TTS Engine, either manually or through software manipulation, extracts at least one context feature and at least one acoustic feature from the imitator voice. When applied to the TTS Engine, the context feature and the acoustic feature of the guide track are extracted and applied to the speech generation process using the voice library in a manner that modifies and enhances the targeted original voice. In this manner, a full range of emotions in a new synthesized speech waveform are generated, which may not be possible to achieve through a TTS Engine alone. Thus, by extracting, correcting, and aligning the context feature and the acoustic feature, the original voice may be enhanced to utter emotion, idiosyncrasies, and characteristics never uttered before by the original voice.

The context and acoustic features are then integrated with the spectral feature predicted from the voice library to generate a new speech wave that enhance the nuances, idiosyncrasies, and emotional expressiveness of the original voice.

The method may include an initial Step of creating a voice library from an original voice. This may include the original voice's vowels, consonants, and vocal gestures, such as laughing, crying, screaming, and whispering.

Another Step of the method comprises recording an imitator voice to form a guide track. An imitator is provided with an input text for synthesis. The imitator may then read the new text of new words that the original voice has never uttered with the same type of rich expressiveness. The guide track stores the imitator voice and parses precise performance information, such as a context feature and an acoustic feature from the imitator voice. The features may then be used to guide an engineer working with a TTS Engine to generate the enhanced speech waveform.

The method may also include a Step of extracting at least one context feature from the imitator voice in the guide track. The context feature is extracted from written transcriptions of the voice data from the imitator voice. The extracted context features may include a phone sequence and a ToBI structure, from the input script. The extraction is performed through a text analysis algorithm together with a dialect-dependent dictionary. The purpose of the context feature extraction is to convert each sentence of an aligned transcription to a set of linguistic and paralinguistic SYMBOLS that describe the pronunciation and prosodic effects of the text. A context feature correction may be applied to the context feature.

A Step comprises combining the at least one context feature with the original voice in the voice library, the voice library comprising a TTS engine. The TTS engine generates a spectra from the context feature. The spectra largely determines the intelligibility of a voice as well as the main vocal characteristics of a voice.

A Step comprises extracting at least one acoustic feature from the imitator voice in the guide track. The acoustic feature is extracted from the voice data from the imitator voice. The extracted acoustic feature comprises pitch, duration, and energy. The acoustic feature may also include, without limitation, amplitude, speed, timbre, breath, pauses, accent, dialect, and vocal gestures. In one embodiment, the acoustic feature has a fundamental frequency (F0) at each frame from the recorded guide tracks. An acoustic feature correction may be applied to the acoustic feature.

The method further comprises a Step of aligning the at least one acoustic feature towards the context features. The alignment creates a segmented guide track. The sequence of extracted and corrected acoustic features is automatically aligned toward the phone sequence using the newly constructed voice library. The phone sequence is a part of the extracted and corrected context features. The alignment may be adjusted with additional manual inspection if any audible misalignment still exists.

A Step includes generating at least one aligned acoustic feature. The aligned acoustic feature copies the duration and F0 of each phone from the acoustic features of the segmented guide track and generates spectral features from the voice library using the context features of the script.

A final Step includes generating a speech waveform from the at least one aligned acoustic feature. The aligned acoustic features are reconstructed as speech waveforms, which include the enhanced original voice. In one exemplary embodiment, a process of HMM-based force alignment is conducted to determine the boundaries of each phones in the recorded imitator voice according to the input text. For each phone, its duration and F0 trajectory are extracted. These duration and F0 features are combined with the spectral features generated by a conventional HMM-based speech synthesis method to reconstruct the final speech waveforms of the enhanced original voice.

One objective of the method is to enhance the original voice by recreate the original voice using text, with a range of emotions that the original voice never said before.

Another objective is to enhance the nuances, idiosyncrasies, emotional expressiveness, and vocabulary of an original voice.

Another objective is to record an imitator voice that substantially matches the original voice.

Another objective is to record the imitator voice into a guide track that can be reused.

Another objective is to extract a context feature and an acoustic feature from the guide track for integration with the original voice in the voice library.

Another objective is to build a digital voice library from a plurality of audio recordings from old movies, Internet, social media, and family recordings.

Yet another objective is to provide enhanced dictionaries for adding vocabulary to the original voice that may never have been uttered before.

Yet another objective is to align the acoustic feature for optimal manipulation in a TTS engine.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a flowchart diagram of an exemplary guide track based speech imitation method, in accordance with an embodiment of the present invention;

FIG. 2 illustrates a block diagram of an exemplary system for voice library construction, in accordance with an embodiment of the present invention;

FIG. 3 illustrates a block diagram of an exemplary system for speech generation, in accordance with an embodiment of the present invention;

FIG. 4 illustrates a block diagram of an exemplary guide track based speech imitation system, in accordance with an embodiment of the present invention; and

FIG. 5 illustrates a block diagram depicting an exemplary client/server system which may be used by an exemplary web-enabled/networked embodiment, in accordance with an embodiment of the present invention.

Like reference numerals refer to like parts throughout the various views of the drawings.

### DETAILED DESCRIPTION OF THE INVENTION

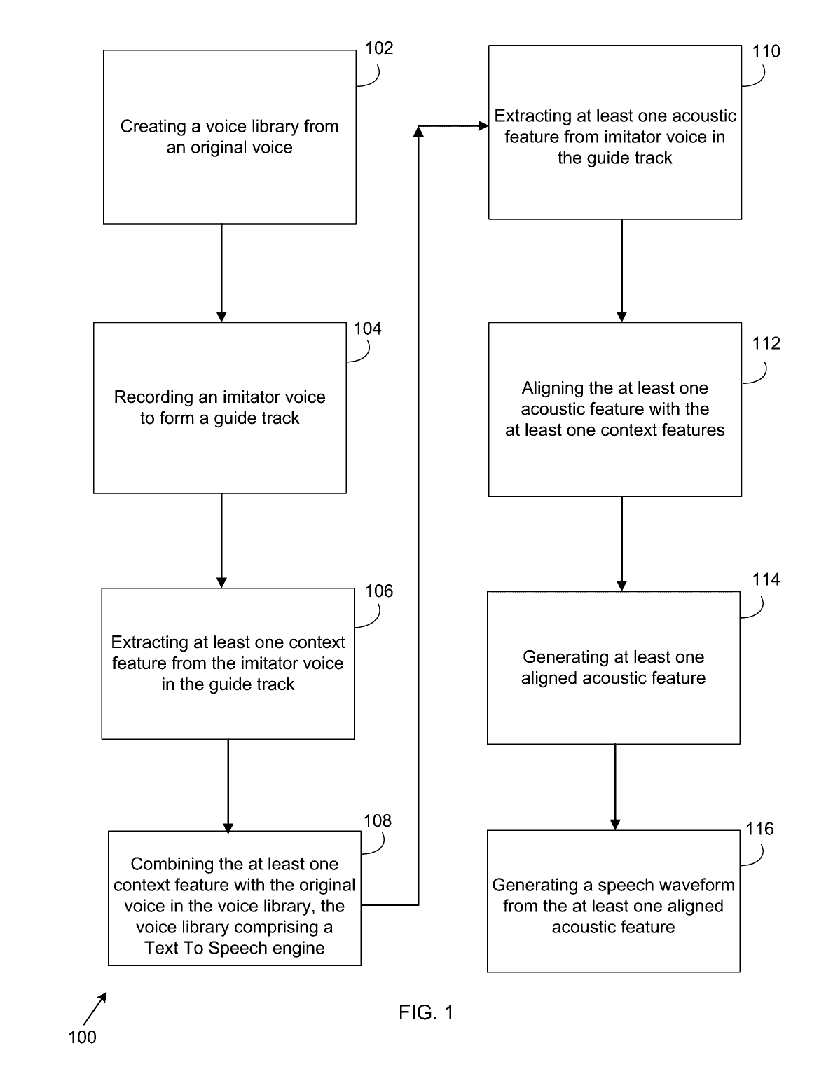

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-5, a guide track 218 based speech synthesis system 200 and method 100 is configured to incorporate voice features and parameters from an imitator voice into a digital voice library 216 containing an original voice, such as the voice of a dead celebrity. The imitator voice attempts to substantially match the vocabulary, cadence, and characteristics of the original voice while reading an input script 222, so as to optimize the speech enhancement. In essence, the imitator voice reads directly from an input script 222 to record words in a guide track 218, in substantially the same manner as the original voice may have spoken. The recorded words are stored in the guide track 218, and corrected, extracted, and aligned therefrom. Prior recordings of audio from the dead celebrity, such as from audio resources 300, are used to build a voice library 216. As discussed above, at least one context feature and at least one acoustic feature are extracted from the guide track 218, corrected, and aligned for integration into the voice library 216.

Then, either manually, or through software the voice data may be manipulated to generate at least one aligned acoustic feature. A TTS Engine then converts the aligned acoustic feature to a speech waveform with the enhanced original voice. The enhanced performance idiosyncrasies and characteristics generated by the TTS engine may include matching the amplitude, cadence, phrasing, rhythm, accent, or dialect of the imitator voice with the original voice. In this manner, the original voice can be recreated using words with a range of emotions that the original voice never expressed.

The present method 100 has two primary goals. A first goal is to prevent anyone from being able to use the guide track method 100 to generate speech content under ANY context—whether it is used for audiobooks, mobile apps, animation, etc., whether it is with or without celebrity voices and regardless of a particular business application. A secondary goal is to prevent the use of speech synthesis (whether through our proprietary guide track method, or the proprietary methods of others) in certain contexts and business applications (ex. using speech synthesis for audio books, animation, ADR, other applications of dead celebrity voices, etc.)

In one possible embodiment, a guide track based speech imitation method 100, hereafter, “method 100”, incorporates an imitator voice into an original voice to enhance the nuances, idiosyncrasies, and emotional expressiveness of the original voice. The original voice may include, without limitation, a dead or living celebrity, or any dead or living person. The imitator voice attempts to substantially match the words, cadence, and emotional sounds of the original voice. The imitator voice may include a professional voice impersonator or any individual. Though, it is significant to note that the technology implemented in the method 200 is not limited to dead celebrities, living celebrities, or an individual. The method 200 may synthesize a voice of any dead or living person or a person or character not yet even conceived (as a result of a fabricated voice).

In some embodiments, the imitator voice reads an input script 222, which is recorded and stored in a guide track 218. The guide track 218 stores and aligns voice parameters, such as at least one context feature and at least one acoustic feature, from the imitator voice. The context feature and the acoustic feature are extracted and incorporated into the original voice through the TTS engine. Thus, because the context feature and the acoustic feature of the original voice are incorporated into the imitator voice, the original voice is enhanced to have improved performance idiosyncrasies and characteristics.

The context feature and the acoustic feature may include spectra, pitch, duration, energy, amplitude, cadence, phrasing, rhythm, accent, or dialect of the imitator voice with the original voice. These are corrected, aligned, and integrated with the original voice in a digital voice library 216. In this manner, the original voice can be recreated using words with a range of emotions that the original voice never expressed.

The initial functions of the method 100 may include, building a voice library 216 from words, phrases, utterances, and emotional sounds of a natural sounding voice. The voice data for the original voice may be obtained from a plurality of audio resources, such as old films, Internet, and social media. The voice library 216 includes a TTS Engine that can be configured to manually, or through speech software, cut recordings of the original voice into sentences and generate the written transcriptions of each sentence in the original voice through a process of manual alignment. The TTS engine may also generate additional enhancement functions, such as noise reduction and channel equalization that are applied to the original voice using a technique of power spectral density matching.

The method 100 may then record an imitator voice into a guide track 218. The imitator voice may include the voice of a professional voice impersonator that is able to substantially match the original voice. It is significant to note that the use of the imitator voice that verbally mimics the original voice is a novel and significant feature of the present invention. The prior art did not incorporate voice parameters from an imitating voice. In one embodiment, the recording of the imitator voice may include text that is read from a script, including the written transcriptions generated in the voice library 216.

Speech parameters of the imitator voice are extracted from the guide track 218. The speech parameters may include at least one context feature, such a phone sequence or ToBI structure. The speech component may also include at least one acoustic feature, such as pitch, duration, and energy. The extracted context feature and acoustic feature are integrated with the original voice in the voice library 216 through the TTS Engine.

The integration of the context feature with the acoustic feature occurs in the TTS engine. The context feature and the acoustic feature are aligned to form at least one aligned acoustic feature. The aligned acoustic feature generates an enhanced speech waveform of the original voice. This may include a higher and more accurate degree of nuances, idiosyncrasies, and emotional expressiveness that the original voice may never have uttered.

As referenced in FIG. 1, the method 100 may include an initial Step 102 of creating a voice library 216 from an original voice. The original voice may include vowels, consonants, and vocal gestures, such as laughing, crying, screaming, and whispering. In one embodiment, the process of creating the voice library 216 includes a digital voice library 216 of vowels, consonants, and vocal gestures of a dead or living celebrity derived from his or her spoken word recordings.

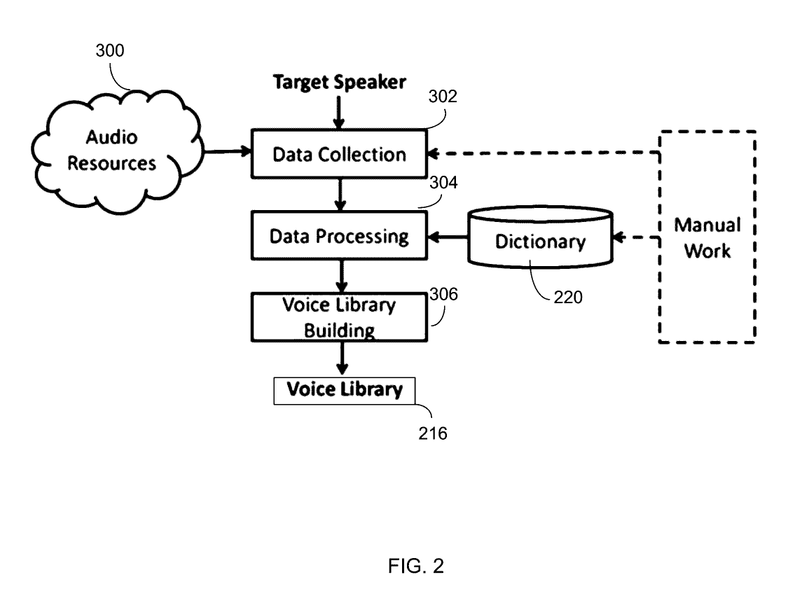

As referenced in the block diagram of FIG. 2, a voice library construction system is configured to build a voice library 216 from accumulation of a plurality of audio resources 300. The audio resources 300 includes spoken word recordings of a dead celebrity collected and archived from the Internet, social media, and various media companies in a data collection step 302. The media may include, without limitation, film, television, radio, news organizations, newspaper, and magazines. The audio resources 300 may also be built from spoken word recordings held in trust by the estate of the dead celebrity and/or other private individuals or organizations. In one embodiment, an audio archivist or librarian may be hired to assist in the assemblage of audio resources 300.

Those skilled in the art will recognize that in building digital voice libraries of other dead or living celebrities, the recordings were often not made under the ideal conditions of a professional recording studio utilizing a vocal booth and high quality microphone. There may be situations when the original source material, i.e., film, television, radio, audio recordings, etc., contains varying degrees of noise or grunge that must be eliminated prior to the construction of a digital library.

Those skilled in the art will also recognize that there are two types of audio processing that may need to be performed in a data processing step 304 to prepare a recording for vowel or consonant information to be extracted for use in a celebrity digital voice library 216. These include: 1) noise reduction, which is a process that cleans up the raw voice data so that the voice quality is sufficiently high and consistent across all recordings; and 2) channel equalization, which is a process that applies linear filtering to enhance the quality of the raw voice data and to improve consistency of voice quality across all sets of recordings.

In one embodiment, the noise reduction process cleans up the raw voice data so that the voice quality is sufficiently high and consistent across all recordings. Towards that end, we will implement the state-of-the-art noise reduction algorithms in our proposed new software, such as spectral reduction, Wiener filtering, or other method 100s. We also, if necessary, will use a state of the art audio processing platform and noise reduction system which incorporates very sophisticated adaptive filtering techniques. These could include various forms of the Cedar Cambridge System, IZotope Software, or other similar systems used for audio repair and enhancement.

In another embodiment, the channel equalization process applies linear filtering to enhance the quality of raw voice data, such as the original voice from the audio resources 300, and to improve consistency of voice quality across all sets of recordings. The channel equalization is implemented by a simple technique of power spectral density matching. The channel equalization addresses conditions where the mismatch among different source recordings is not so serious, such as the audiobook recordings. However, more sophisticated techniques, such as a 4-band Parametric EQ, may be necessary to be integrated into software development in order to make full use of the speech data of the original voice recorded under different conditions. Once the voice data is arranged, a voice library 216 building step 306 is possible.

Another Step 104 of the method 100 comprises recording an imitator voice to form a guide track 218. In one embodiment, a voice impersonator is provided with an input script 222 for synthesis. The voice impersonator may then read the new text of new words that the original voice has never uttered with the same type of rich expressiveness. The guide track 218 stores the imitator voice and parses precise performance information, such as a context feature and an acoustic feature from the imitator voice. The context and acoustic features may then be used to guide an engineer working with a TTS Engine to generate the enhanced speech waveform. In one possible embodiment, the guide track 218 is made by an actor who recites new text with his or her impression of how the dead celebrity would actually perform the input script 222.

The method 100 may also include a Step 106 of extracting at least one context feature from the imitator voice in the guide track 218. The context feature is extracted from written transcriptions of the voice data from the imitator voice. The extracted context features may include a phone sequence and a ToBI structure, from the input script 222. Those skilled in the art will recognize that the phone sequence is the unit of sound in a language. The extraction is performed through a text analysis algorithm together with a dialect-dependent dictionary 220. The purpose of the context feature extraction is to convert each sentence of an aligned transcription to a set of linguistic and paralinguistic Symbols that describe the pronunciation and prosodic effects of the text.

The at least one context features is combined with the voice library 216 to generate a spectra feature. The spectra includes variables are the result of spectral analysis, which decomposes the speech waveform into a group of sinusoidal waves with different frequencies. The resulting spectra reflect the influence of the configuration of the entire vocal tract shaped by the positions of tongue, lips, and velum inside the mouth during pronunciation of a specific word. The spectra also reflects the influence of the vocal cords during the pronunciation.

After the voice library 216 for a dead or living celebrity has been built, the context feature information must accurately predict the four acoustic feature parameters, i.e., spectra, pitch, duration, energy, described above before the speech waveforms can be reconstructed. The purpose of context feature extraction is to convert each sentence of an aligned transcription to a set of linguistic and paralinguistic Symbols that describe the pronunciation and prosodic effects of the text. The Symbols can be divided into three main groups:

A first group of Symbols is a phonetic symbol. The phonetic symbol is the phonetic label of each phone, i.e. the unit of sound in a language, in the sentence.

A second group is a prosodic symbols. Those skilled in the art will recognize that prosody is the rhythm, stress, and intonation of speech. Prosodic symbols refers to a group of symbols which are used to describe the prosodic characteristics of the speech. This can include: 1) The hierarchical prosodic structure of a sentence, including the boundaries of syllables, words, phrases, and sentences; 2) The stressed syllable within each word, with each word generally having either none or only one stressed syllable in it; 3) the accented word within each phrase; and 4) The boundary tone of each phrase, i.e. the rising tone (or pitch) or the falling tone (or pitch) at the end of each phrase.

The present invention defines the prosodic symbols by using a subset of the symbols of ToBI, (http://www.ling.ohio-state.edu/˜tobi/), which is a set of conventions for transcribing and annotating the prosody of speech. The details of the prosodic symbols we used can be found in the following examples:

1) Syntactic symbols: refers to the Part-of-Speech of each word in the sentence. For example: Input text: “Harry Potter and the Sorcerer's Stone.” Here is an example of how the output of the CFE step is written: Line 1: Harry*Potter#and*the*Sorceree's*Stone|

Line 2: [hh eh1 r(H*)/iy][p aa1 t/er(L−L %)P][ae1 n d][dh ax][s ao1 r s(H*)/er/er][z][s t ow1 n(L−L %)P]
Line 3: Harry/nnp Potter/nnp and/cc the/dt Sorcerer/nn's/pos
Stone/nn
   There are three lines of the outputs. They contain: a) Phonetic symbols: the sequence “hh eh r iy p aa . . . ” in Line 2
   2) Prosodic symbols:
a) Prosodic structure: The “/” in Line 2 indicate the syllable boundaries; the “*” in Line 1 and the “[ ]” in Line 2 indicate the word boundaries; the “#” in Line 3 indicate the phrase boundaries; the “|” at the end of Line 1 is the sentence boundary.
b) The vowel ended with “1” in Line 2 indicate the syllable should be stressed in the word. For example, the ‘eh1’ in the first word indicates that this syllable should be stressed in the word “Harry”.
c) A syllable labeled with (H*) or (L*) in Line 2 indicate that the word contains this syllable should be accented. For example, the word “Harry”, “Sorcerer” in this sentences. The symbols (H*) and (L*) are borrowed from the ToBI system 200. (H*) means to represents an accented word using high F0/pitch. (L*) means to represents an accented word using low F0/pitch.
d) At the end of each phrase, we can see a symbol of (L−H %) or (L−L %) in Line 2, which are the symbols for the boundary tone of each phrase. (L−H %) means a rising tone and (L−L %) means of falling tone. In the above example, both phrases have falling tones. The symbols of (L−H %) and (L−L %) are also borrowed from the ToBI system 200. A symbol “P” is also apparent behind (L−L %) in Line 2. The P means the position for insertion of a pause.
   3) Syntactic symbols: Line 3 gives the Part-of-Speech labels of each word.

In some embodiments, a dictionary 220 provides the mapping from each word to its corresponding phonetic symbols. It is a key component of the context feature extraction mentioned above. One example, is a segment of an American English dictionary 220.

(“accessibility” nil (ae1 k s eh0 s ax b ih1 1 ih0 t iy0))
(“accessible” nil (ae0 k s eh1 s ax b ax 1))
(“accessing” nil (ae1 k s eh1 s ih0 ng))
(“accession” nil (ax k s eh1 sh ax n))
(“accessories” nil (ae0 k s eh1 s er0 iy0 z)) We can see how it spells out each word by indicating a group of phonetic symbols.

In the context feature extraction, all three groups of symbols are derived from the input text. Extracting some of them may be less ambiguous or easier than others. However, to extract all of these symbols required for high-end theatrical applications may not be an easy proposition. For example, the symbols related to phonetic identity and stress positions may be obtained in a straightforward manner by looking them up in a dictionary 220. However, for some person or place names that are not contained in a dictionary 220, obtaining a correct spelling by computer program may be cumbersome. In addition, difficult and complicated machine learning techniques are required to predict the symbols related to the phrase boundaries, boundary tones and accent positions in sentences. To improve the performance of such predictions is essential to high-end theatrical applications, which is one objective of the method 100.

The enhanced context feature extraction software give provides unique capabilities, including: 1) the ability to predict the phonetic symbols of a word which is not contained in the dictionary 220; and 2) the ability to make more accurate prediction of the phrase boundary and accent positions for an input sentence, etc.

The present invention predicts a next generation of software tools that integrate these and other factors into account so as to remove a substantial portion of current limitations that currently prevent a particular celebrity voice from being authentically duplicated. These other factors will provide additional levels of labeling and a greater range of flexibility needed to precisely duplicate a celebrity voice.

In some embodiments, the dictionary 220 may be language and dialect dependent. Proper pronunciation may be found, for example, in a standard Webster's Dictionary. However, for certain persons with geographical or ethnic dialects and for words that may not readily be found in the dictionary 220, finding the correct spelling from a computer program is not always an easy or accurate proposition.

The dictionary 220 generally corresponds to the pronunciation of the speaker. However, this is not always the case. Those skilled in the art will recognize that there are occasions when additional dictionaries are needed that reflect the particular dialect of a speaker. For example, besides Appen and Speech Ocean, there are other American/British English dictionaries that are available for research applications. Even with these, however, their accuracy may or may not satisfy all of the requirements of high-end theatrical commercial applications. Thus, manually checking may be needed to guarantee the accuracy of the dictionaries.

In one exemplary embodiment, manual checking, occurs after the voice library 216 of the original voice has been created. There were difficulties in accurately reproducing words that contained the syllable “au” such as found in the words “audio” and “authentic” contained in the input script 222. This problem may be attributed to a pronunciation deficiency found in the dictionary 220.

In one experimental embodiment, the problem was remedied by utilizing one or more of the following method 100s: 1) performing “voice surgery” to modify some resonance characteristics of the sound; 2) changing a few prosodic properties by hand using a software tool; and 3) simply cutting a sound from another place in the sentence and pasting it in the problematic sound.

Furthermore, a context feature correction may be applied to the context feature. The context features are automatically corrected according to the authentic and accurate pronunciation of the desired individual whose vocal characteristics and emotional speech patterns are being duplicated by means of a voice impersonator using a guide track 218 consisting of the imitator voice reciting new text as well as additional manual revisions conducted by an expert of phonetics, as needed.

A Step 108 comprises combining the at least one context feature with the original voice in the voice library 216, the voice library 216 comprising a TTS engine. The TTS engine manipulates the context feature to generate a spectra from the context feature. The spectra largely determines the intelligibility of a voice as well as the main vocal characteristics of a voice.

It is significant to note that the voice library 216 is built using these extracted context and acoustic features to represent the mapping relationship from the context feature to the acoustic feature. Those skilled in the art will recognize that to collect and process the data needs manual work that is time consuming. After that, building the voice library 216 requires heavy computation. It may take a high performance computer several days to complete the mathematical computation needed to build the digital voice library 216. However, this process only needs to occur one time for a given original voice.

A Step 110 comprises extracting at least one acoustic feature from the imitator voice in the guide track 218. The acoustic feature is extracted from the voice data from the imitator voice. The extracted acoustic feature comprises pitch, duration, and energy. The acoustic feature may also include, without limitation, amplitude, speed, timbre, breath, pauses, accent, dialect, and vocal gestures. In one embodiment, the acoustic feature has a fundamental frequency (F0) at each frame from the recorded guide track 218.

As described above, one possible acoustic feature is pitch. The pitch describes the contours or shape of intonation, determining the highs and lows of a sound perceived by the listener. Pitch is closely related to the parameter of “F0”, which is the frequency of the vocal fold vibration when a person pronounces a vowel of a voiced consonant. Its unit of measurement is in Hertz. High F0 leads to high pitch and/or a higher perceived tone or intonation. The range of F0 for human voice is approximately 60-400 Hz, with female voices being higher than a male voice and with children voices even higher.

Another acoustic feature is duration. This variable describes the length of each sound in the fluent voice.

Yet another acoustic feature is energy. This variable relates to the perceived loudness of each sound in the fluent voice. The more force a person uses to produce the sound, the higher energy it has.

An acoustic feature correction may be applied to the at least one acoustic feature. Some additional manual work is conducted in the event that there are some audible feature extraction errors generated during extraction of the acoustic feature. Finally, the four acoustic features (spectra, pitch, duration, and energy) are integrated to generate the specific speech waveform for the original voice. The four above mentioned variables have important and functionally different roles in determining the overall quality of the synthetic voice sounds (i.e., the sounds generated by the computer in conjunction with the vocal guide track).

For example, the spectra largely determines the intelligibility of the voice as well as the main vocal characteristics of the speaker. The remaining three parameters are mainly responsible for the prosodic effects of the voice including the prominence of the information that the speaker intends to convey. There can, however, be a subtle but noticeable trade-off that can occur in accordance with how the three remaining parameters are used. This involves a process of manipulating the variables of pitch, duration, and energy to produce a guestimate of how a dead celebrity would actually recite the new input script 222.

The method 100 further comprises a Step 112 of aligning the at least one acoustic feature towards the context features. The alignment creates a segmented guide track 218. The sequence of extracted and corrected acoustic features is automatically aligned toward the phone sequence using the newly constructed voice library 216. The phone sequence is a part of the extracted and corrected context features. The alignment may be adjusted with additional manual inspection if any audible misalignment still exists.

A Step 114 includes generating at least one aligned acoustic feature. The aligned acoustic feature copies the duration and F0 of each phone from the acoustic features of the segmented guide track 218 and generates spectral features from the voice library 216 using the context features of the script. The aligned acoustic feature is the most refined voice data, and is used for generating the final product of an enhanced speech waveform.

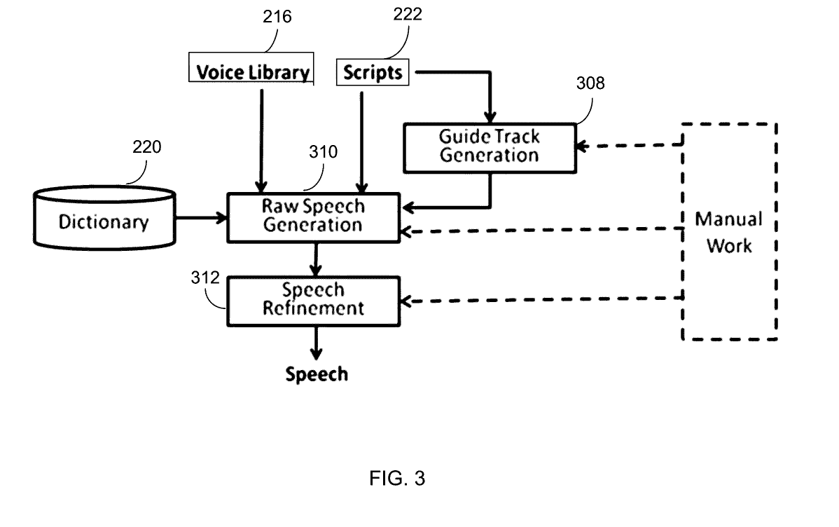

A final Step 116 includes generating a speech waveform from the at least one aligned acoustic feature. The final speech waveform is basically a regeneration of raw voice data into enhanced original voice. As described above, the generation of the guide track 218 from the imitator voice reading the input script 222 is the key initial step. This is embodied in a speech generation system 200, referenced in FIG. 3. In this system, a guide track 218 generation step 308 records the imitator voice and corrects the correlating context feature and acoustic feature accordingly. A raw speech generation step 310 receives the context feature and acoustic feature from the guide track 218, and through use of the dictionary 220 and software or manual manipulations, generates an aligned acoustic waveform.

Subsequently, in a speech refinement step 312, the aligned acoustic features are reconstructed as speech waveforms, which include the enhanced original voice. In one exemplary embodiment, a process of HMM-based force alignment is conducted to determine the boundaries of each phones in the recorded imitator voice according to the input text. For each phone, its duration and F0 trajectory are extracted. These duration and F0 features are combined with the spectral features generated by a conventional HMM-based speech synthesis method to reconstruct the final speech waveforms of the enhanced original voice.

Another aspect of the new software to be developed includes the new capability of directly modifying the resonance characteristics of the synthesized speech. Resonance frequencies are the most important characteristics for speech intelligibility. Each vowel in the world languages consists of a distinct set of resonance frequencies, typically ranging from F1 (first resonance) to F2 (second resonance) and F3 (third resonance). They are closely related to the vocal tract shape within the mouth and throat in producing the vowel. Different shapes of the vocal tract correspond to different {F1, F2, F3} patterns, which distinguish one vowel from another. The movement over time of these three patterns signifies how the speech sounds flow as they come out of the mouth.

Those skilled in the art will recognize that this enables an audio engineer to manipulate F1, F2, and/or F3 to change from one sound to another (either consonant or vowel). The ability of our audio engineers to do such manipulation requires special skills and knowledge on the subtlety of the effects of resonances on the perception of speech sounds. In the context of high-fidelity speech synthesis, most aspects of imperfection may be corrected via careful manipulation of {F1, F2, F3}.

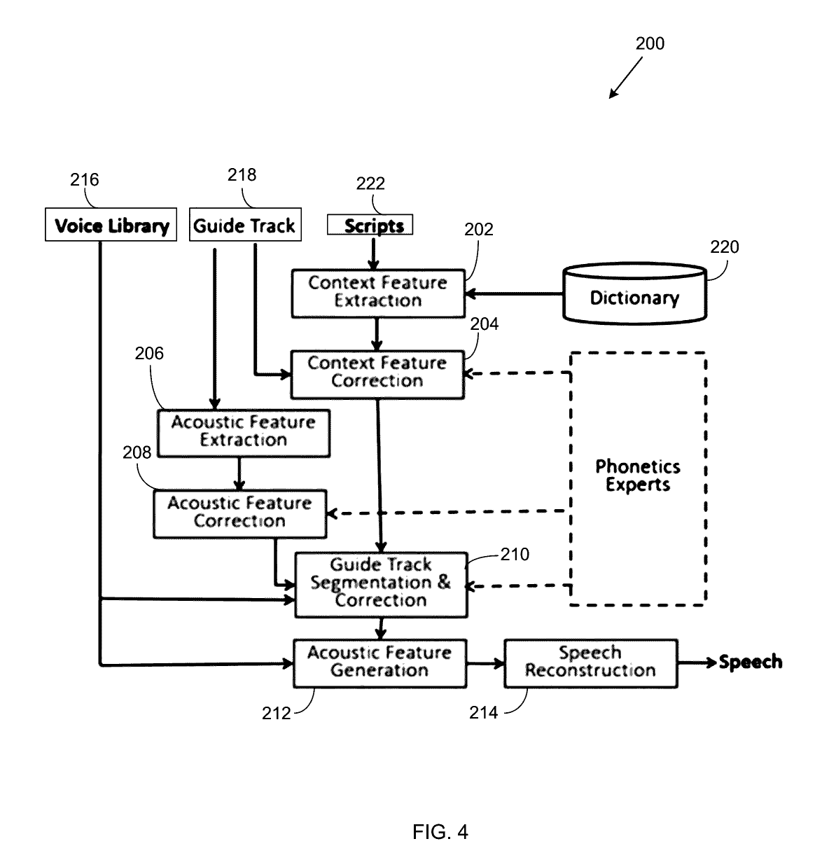

As illustrated in FIG. 4, a guide track based speech imitation system 200, hereafter, “system 200” enhances the performance idiosyncrasies and characteristics of an original voice through manipulation of voice parameters from a recorded imitator voice. The verbal mimicry and the use of voice parameters, such as at least one context feature and at least one acoustic feature enables accurate and rich replication of the original voice. The system 200 incorporates an imitator voice with an original voice, and then utilizes software or manual manipulations to correct, align, and mix the context feature and acoustic feature, such that the original voice speaks with rich character and emotion that was never uttered before.

In one exemplary embodiment, the imitator voice is recorded in a guide track 218 to substantially match the original voice. Separately, the original voice is constructed in a voice library 216. Using the context feature and acoustic feature from the imitator voice, a TTS engine, either manually or through software manipulation, extracts at least one context feature and at least one acoustic feature from the imitator voice. When applied to the TTS Engine, the context feature and the acoustic feature of the guide track 218 are extracted and applied to the speech generation process using the voice library 216 in a manner that modifies and enhances the targeted original voice.

In this manner, a full range of emotions in a new synthesized speech waveform are generated, which may not be possible to achieve through a TTS Engine alone. Thus, by extracting, correcting, and aligning the context feature and the acoustic feature, the original voice may be enhanced to utter emotion, idiosyncrasies, and characteristics never uttered before by the original voice. As FIG. 4 illustrates, the system 200 comprises multiple modules that are used to perform the aforementioned functions.

In one embodiment, a context feature extraction module 202 extracts context features, including the phone sequence and the ToBI structure, from the input script 222. This is done utilizing a text analysis algorithm together with a dialect-dependent dictionary 220. A context feature correction module 204 enables the context features to be automatically corrected according to the authentic and accurate pronunciation of the desired individual whose vocal characteristics and emotional speech patterns are being duplicated by means of a voice imitator using a guide track 218 consisting of him reciting new text as well as additional manual revisions conducted by an expert of phonetics, as needed.

An acoustic feature extraction module 206 is configured to extract acoustic features, especially the fundamental frequency (F0) at each frame, from the recorded guide track 218s. The acoustic feature is extracted from the voice data from the imitator voice. The extracted acoustic feature comprises pitch, duration, and energy. In some embodiments, an acoustic feature correction module 208 is configured to correct the acoustic features. Some additional manual work is conducted in the event that there are some audible feature extraction errors generated by the previous module.

A guide track 218 segmentation and correction module 210 is operable to automatically align the sequence of extracted and corrected acoustic features towards the phone sequence using the newly constructed voice library 216. The phone sequence is a part of the extracted and corrected context features. Then, additional manual inspection and correction can be conducted if any audible misalignment still exists. An acoustic generation module 212 copies the duration and F0 of each phone from the acoustic features of the segmented guide track 218 and generates spectral features from the voice library 216 using the context features of the script. Finally, a speech reconstruction module 214 is configured to reconstruct speech waveforms from the aligned acoustic features generated by the acoustic generation module 212.

The speech synthesis method 100 and system 200 has a myriad of business applications. Those skilled in the art will recognize that replicating a natural sounding voice of a dead or living celebrity has great commercial potential. For example, without limitation, advertisements could play on the consumer's nostalgia appeal of a past celebrity—especially for an older audience, or a living celebrity for a general audience. There could be other uses as well not yet imagined or produced for the method 100 and system 200. For example, other possible uses include, but are not limited to: Movie Production; Television Production; Animation Production; Advertising Production; Radio Production; Theatrical Production; Foreign Language Dubbing for Film and Television; ADR Foley Post Production Applications; GPS Applications; Smart Phone Applications; Internet; Social Media; Video Games; Speaking Holograms for retail, amusement theme parks, museums and corporate events; Dolls/Toys/Novelty items; Audio Books, such as authors reading their own books; Holiday Greeting Cards including birthday, anniversary, get well, Christmas, New Years, and Valentine's Day Cards, etc.; Computer Board Games; Airlines; Trains; Buses; Public Transportation Centers; Schools; and Public Service Announcements.

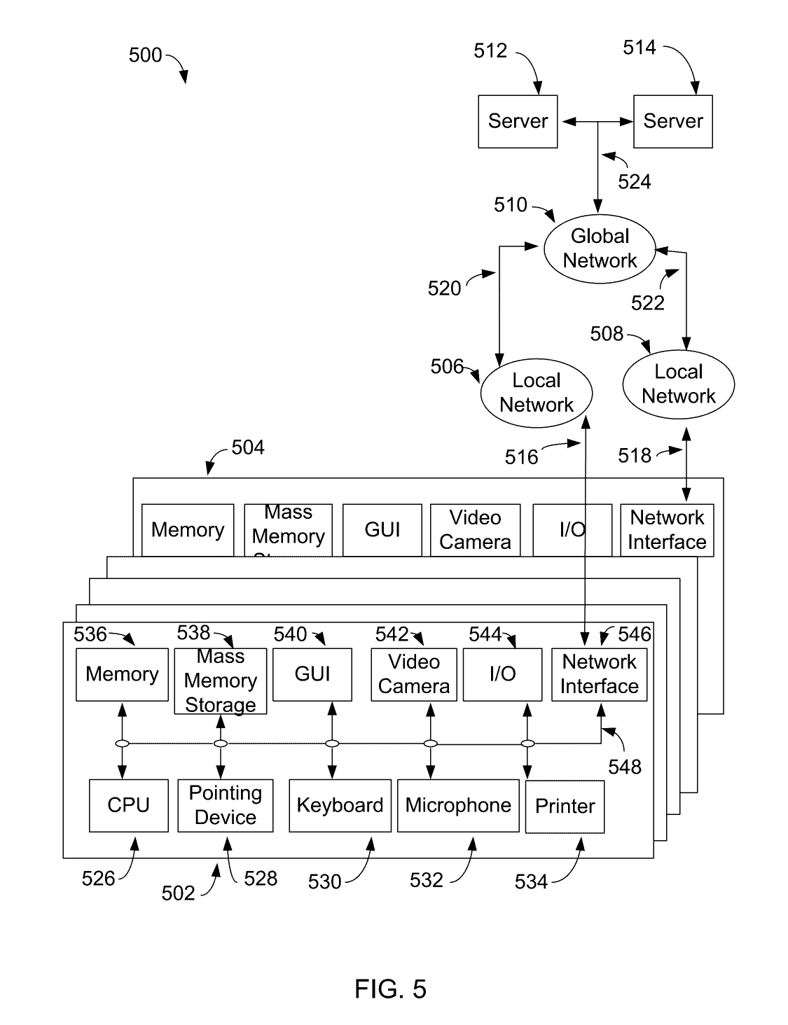

FIG. 5 is a block diagram depicting an exemplary client/server system which may be used by an exemplary web-enabled/networked embodiment of the present invention.

In one embodiment, a communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A guide track based speech synthesis method for enhancing expressiveness of the speech synthesized from texts with context features and acoustic features extracted from an imitator voice, the method comprising:
creating a voice library from an original voice;
recording an imitator voice according to input script to form a guide track;
extracting at least one context feature from the input script and the guide track;
extracting acoustic features, including prosodic features and spectral features from the guide track;
aligning the acoustic features towards the at least one context feature;
predicting spectral features from the voice library using the at least one context feature and the alignment results; and
generating a speech waveform using the spectral features predicted from the voice library and the prosodic features extracted from the guide track.

2. The method of claim 1, wherein the original voice includes the recording speech of at least one member selected from the group consisting of: a celebrity voice, a dead person, and a family member.

3. The method of claim 1, wherein the imitator voice is a professional voice imitator.

4. The method of claim 1, wherein the step of recording an imitator voice to form a guide track comprises reading an input script.

5. The method of claim 1, wherein the voice library is a statistical acoustic model.

6. The method of claim 1, wherein the at least one context feature includes a phone sequence and a ToBI structure for English.

7. The method of claim 1, wherein the prosodic features include a fundamental frequency and an energy for each speech frame.

8. The method of claim 1, wherein the step of creating a voice library from an original voice further comprises creating a voice library from accumulation of a plurality of audio resources, the plurality of audio resources defined by spoken word recordings of a dead celebrity or any dead or living person collected and archived from the Internet, social media, old recordings, and old films.

9. The method of claim 1, wherein the step of predicting spectral features from the voice library, further comprises converting the at least one context feature of each sentence to a set of linguistic and a plurality of paralinguistic symbols that describe the pronunciation and prosodic effects of the input script.

10. The method of claim 9, wherein the set of linguistic and the plurality of paralinguistic symbols includes phonetic symbols, prosodic symbols, and syntactic symbols.

11. A guide track based speech synthesis system for a guide track based speech imitation method for enhancing expressiveness of the speech synthesized from texts with context features and a acoustic feature extracted from an imitator voice, the system comprising:
a context feature extraction module, the context feature extraction module configured to extract at least one context feature from an imitator voice;
a context feature correction module, the context feature correction module configured to provide an interface for manually correcting the at least one context feature according to an authentic and accurate pronunciation of the imitator voice;
an acoustic feature extraction module, the acoustic feature extraction module configured to extract prosodic and spectral features from the imitator voice;
an acoustic feature correction module, the acoustic feature correction module configured to provide an interface for manually correcting the extracted prosodic features;
a guide track segmentation and correction module, the guide track segmentation and correction module configured to automatically align a sequence of extracted and corrected acoustic features towards a phone sequence with manual corrections;
an acoustic generation module, the acoustic generation module configured to predict spectral features from the voice library using the context features and the alignment results; and
a speech reconstruction module, the speech reconstruction module configured to reconstruct a speech waveform from the spectral features generated by the acoustic generation module, and the prosodic features given by the an acoustic feature extraction/correction module.

12. The system of claim 11, wherein the original voice includes at least one member selected from the group consisting of: a celebrity voice, a dead person, and a family member.

13. The system of claim 11, wherein the imitator voice is a professional voice imitator.

14. The system of claim 11, wherein the prosodic features include a fundamental frequency and an energy for each speech frame.

15. The system of claim 11, wherein the context features include a phone sequence and a ToBI structure for English.

16. The system of claim 11, wherein the step of the acoustic generation module, further comprises converting the context features of each sentence to a set of linguistic and paralinguistic Symbols that describe the pronunciation and prosodic effects of the input script.

17. The system of claim 16, wherein the set of linguistic and paralinguistic symbols includes phonetic symbols, prosodic symbols, and syntactic symbols.
